(19) United States
(12) Patent Application Publication
(10) Pub. No.: US 2009/0164319 A1
(43) Pub. Date: Jun. 25, 2009

(54) DISCOUNT SYSTEM AND METHOD

(75) Inventors: Ryan Kole, Chicago, IL (US); Julius Kole, Northbrook, IL (US); Frederick Held, Palos Verdes Estates, CA (US); Rodney A. Castello, Studio City, CA (US)

Correspondence Address: WILDMAN HARROLD ALLEN & DIXON LLP, 225 WEST WACKER DRIVE, SUITE 2800, CHICAGO, IL, 60606, US

(73) Assignee: JRK Investments, LLC, Chicago, IL (US)

(21) Appl. No.: 12/338,278

(22) Filed: Dec. 18, 2008

Related U.S. Application Data
(60) Provisional application No. 61/014,990, filed on Dec. 19, 2007.

(51) Int. Cl. G06Q 30/00

(52) U.S. Cl. 705/14

(57) ABSTRACT

Discount systems and methods of providing discounts are provided. The discount systems may include an apparatus couplable to an automobile. The apparatus may include indicia thereon relating to an entity desiring to provide a discount upon detection of the apparatus. In some aspects, the apparatus may be a license plate frame. The methods may include providing an apparatus including indicia thereon associated with an entity, coupling the apparatus to an automobile, detecting the presence of the apparatus at a location associated with the entity, and providing a discount for a product or a service associated with the entity after detection of the apparatus. In some aspects, the apparatus may be a license plate frame and the license plate frame may be coupled to an automobile such that the apparatus at least partially surrounds a license plate coupled to the automobile,

### RELATED APPLICATIONS

The present application claims the benefit of co-pending U.S. Provisional Patent Application No. 61/014,990, filed Dec. 19, 2007, the entire contents of which are incorporated herein by reference.

### FIELD OF THE INVENTION

The present invention generally relates to discount systems and methods and, more particularly, relates to discount systems and methods including a license plate frame or other apparatus associated with an automobile.

### SUMMARY

In some aspects, a method of providing a discount is provided and includes providing a license plate frame including indicia thereon associated with an entity, coupling the license plate frame to an automobile such that the license plate frame at least partially surrounds a license plate coupled to the automobile, detecting the presence of the license plate frame at a location associated with the entity, and providing a discount for a product or a service associated with the entity after detection of the license plate frame.

In other aspects, a method of discounting is provided and includes providing an apparatus including indicia thereon associated with an entity that sells a product or a service, coupling the apparatus to an automobile, driving the automobile to a first location not associated with the entity, detecting the presence of the apparatus at the first location, driving the automobile to a second location associated with the entity, detecting the presence of the apparatus at the second location, and providing a discount for a product or a service associated with the entity after detection of the apparatus at the second location.

In further aspects, a method of providing a discount is provided and includes providing a license plate frame including indicia thereon associated with an entity, coupling the license plate frame to an automobile such that the license plate frame at least partially surrounds a license plate coupled to the automobile, driving the automobile to a first location not associated with the entity, visually detecting the presence of the license plate frame at the first location, driving the automobile to a second location associated with the entity, detecting the presence of the license plate frame at the second location, and providing a discount for a product or a service associated with the entity after detection of the license plate frame.

In yet further aspects, a discount system for providing a discount for a product or a service associated with an entity is provided and includes a license plate frame operable to be coupled to an automobile such that the license plate frame at least partially surrounds a license plate, the license plate frame including indicia thereon associated with the entity.

In still further aspects, a discount system is provided and includes an apparatus couplable to an automobile, the apparatus including indicia associated with an entity that sells a product or a service, wherein the entity provides a consumer owning the automobile a discount upon detection of the apparatus at a location associated with the entity. The apparatus may be a license plate frame and the indicia may be an entity's name, entity's web address, entity's phone number, or other information associated with the entity.

Independent features and independent advantages of the present invention will become apparent to those skilled in the art upon review of the detailed description and drawings.

### BRIEF DESCRIPTION OF THE DRAWINGS

FIG. 1 is a perspective view of an exemplary discount system;

FIG. 2 is a front view of an exemplary license plate frame of the discount system shown in FIG. 1;

FIG. 3 is a flowchart illustrating an exemplary method of discounting associated with the exemplary discount system shown in FIG. 1;

FIG. 4 is a diagram of an exemplary computer processing system of the exemplary discount system shown in FIG. 1;

FIG. 5 is an exploded perspective view of another exemplary license plate frame of the discount system shown in FIG. 1, shown exploded from an exemplary license plate;

FIG. 6 is a rear perspective view of the exemplary license plate frame shown in FIG. 5;

FIG. 7 is an enlarged perspective view taken from FIG. 6, the enlarged view is of a portion of the exemplary license plate frame;

FIG. 8 is an exploded perspective view of the exemplary license plate frame shown in FIG. 5, shown exploded from an exemplary license plate and an exemplary existing license plate frame; and

FIG. 9 is an exploded perspective view of another exemplary license plate frame of the discount system shown in FIG. 1.

Before any independent features and embodiments of the invention are explained in detail, it is to be understood that the invention is not limited in its application to the details of the construction and the arrangement of the components set forth in the following description or illustrated in the drawings. The invention is capable of other embodiments and of being practiced or of being carried out in various ways. Also, it is understood that the phraseology and terminology used herein is for the purpose of description and should not be regarded as limiting.

### DETAILED DESCRIPTION

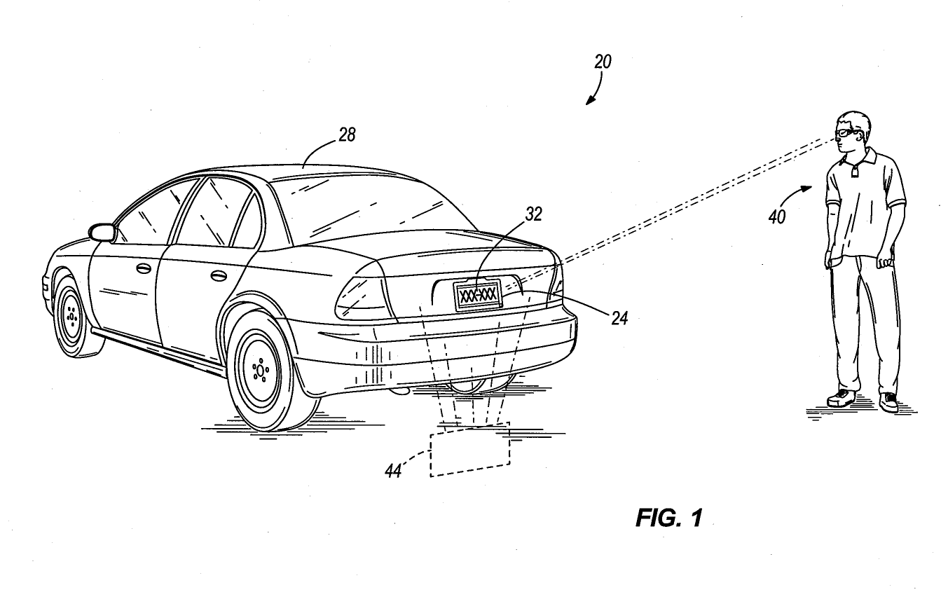

With reference to FIG. 1, an exemplary discount system 20 is illustrated and includes an apparatus 24 coupled to an automobile 28. In the illustrated construction, the apparatus 24 is a license plate frame 24, which may be coupled to the automobile 28 or to a license plate 32 such that the frame 24 surrounds the rear license plate 32 of the automobile 28. Alternatively, the license plate frame 24 may be coupled to a front of the automobile 28 adjacent to and surrounding a front license plate 32, or a license plate frame 24 may be coupled to the automobile 28 adjacent to and surrounding both the front and rear license plates 32. Also, in the alternative, the apparatus 24 can be other items, such as, for example a magnet coupled to the automobile 28, a decal coupled to the automobile 28, a sign displayed in a window of the automobile 28, a sign hanging from the rearview mirror of the automobile 28, a flag or other device coupled to an antenna of the automobile 28, a flag coupled to the automobile 28 via a window, a display or sign coupled to a top of the automobile 28, an electronic sign, such as a flashing message sign, coupled to the automobile 28, a device coupled to or writing on a wheel or wheels of the automobile 28, and the like. In the following description and drawings, the exemplary license plate frame 24 will be referenced, however, as indicated above, the apparatus 24 may be other types of items and reference to the license plate frame 24 in the following description and drawings is not meant to be limiting. Accordingly, the concepts described and shown are also applicable to alternatives of the apparatus 24.

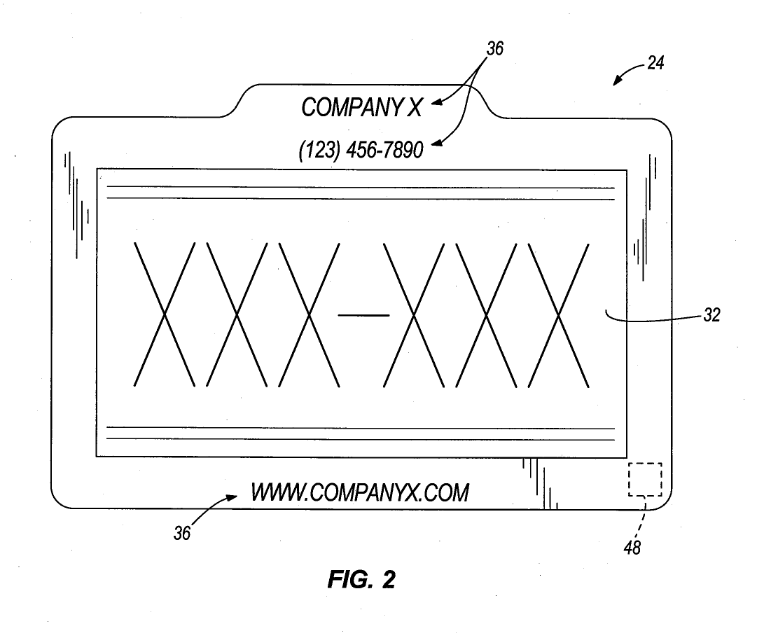

With reference to FIG. 2, the license plate frame 24 includes indicia 36 associated with an entity that sells products or services. The indicia 36 can relate to different types of information associated with the entity such as, for example, entity's name, entity's website, entity's phone number, entity's logo, entity's slogan, illustrations associated with the entity, a discount received through use of the license plate frame, etc. The license plate frame 24 can also have a color or a plurality of colors associated with the entity.

The license plate frame 24 is part of the exemplary discount system 20 that provides a discount to a consumer having the license plate frame 24 on their automobile 28. The presence of the license plate frame 24 also provides advertising for the entity associated with the license plate frame 24. As used herein, the term discount is meant to encompass the normal meaning of the term discount along with rebates, point accumulation rewards, or other types of consumer rewards for utilizing the license plate frame 24. Entities that may be associated with the license plate frame 24 include, but are not limited to, restaurants (sit-down and drive-thru), automobile service companies, car rental and sales companies, etc. In fact, any type of entity interested in advertising and providing discounts may be associated with the exemplary discount system 20.

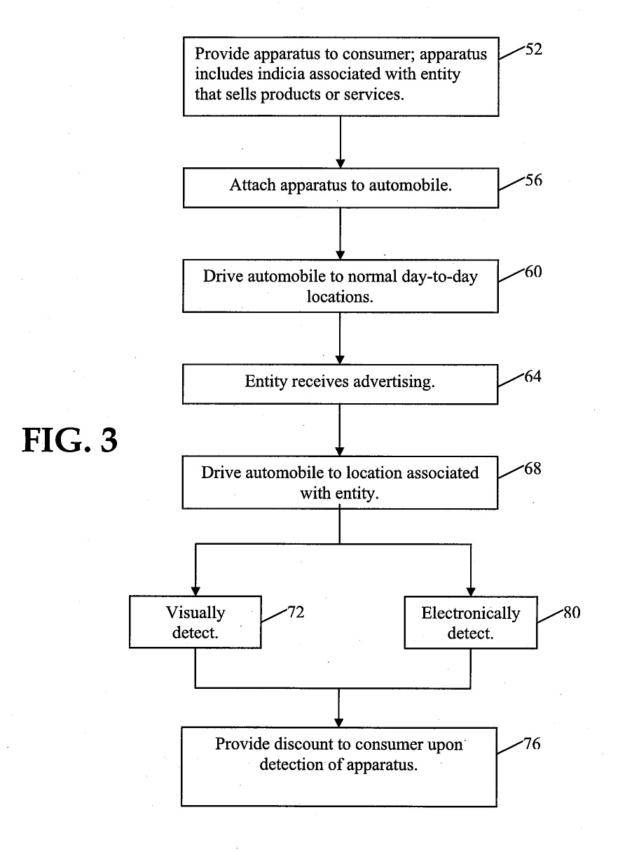

With reference to FIG. 3, the discount system 20 operates in at least two manners. In a first manner of operation, an entity provides the license plate frame 24 to a consumer at step 52. The consumer or a representative of the entity may couple the license plate frame 24 to the consumer's automobile 28 adjacent to and surrounding a license plate 32 at step 56. The consumer drives the automobile 28 day-to-day as is normal to the consumer as represented at step 60. During this normal automobile 28 operation, the license plate frame 24 is visible to other automobile operators and pedestrians, thereby providing advertising (step 64) for the entity associated with the indicia 36 on the license plate frame 24. The consumer then visits a location associated with the entity with the license plate frame 24 coupled to the automobile 28 at step 68. A person 40 (see FIG. 1) associated with the entity, such as an employee, visibly detects or identifies the presence of the license plate frame 24 at step 72 and the consumer is provided with a discount on a product or service offered by the entity at step 76. In addition, a discount may be provided upon initially coupling the frame 24 to the automobile 28.

The first manner can also include the following additional features or variations to those features listed above. The license plate frame 24 can be provided to a consumer at a location associated with the entity (e.g., at the entity's place of business), at a location not associated with the entity (e.g., not at the entity's place of business), or mailed or otherwise distributed to the consumer. The license plate frame 24 can be provided to the consumer at a fee or can be provided to the consumer at no cost. The consumer can either couple the license plate frame 24 to the automobile on his/her own or a person associated with the entity can couple frame 24 at the consumer's request. The consumer may receive a discount in a variety of forms. For example, a consumer may receive a free product or service, may receive a product or service at a discounted rate (e.g., a percentage discount or a fixed dollar amount discount), may receive a coupon for his/her next visit, may receive mail-in rebate to recoup a portion or the entire cost associated with the product or service, may accumulate points each time the consumer visits a location associated with the entity and receive discounts upon accumulation of a sufficient amount of points or any other type of discount, may be entered in contests where prizes are awarded, may qualify for instant giveaways, etc.

The second manner of operation of the discount system 20 is similar to the first manner except for detecting the presence of the license plate frame 24. Rather than detecting the presence of the license plate in a visual manner as is accomplished in the first manner at step 72, electronics are utilized to detect the presence of the license plate frame 24 at a location associated with the entity at step 80. More particularly, the entity can include a sensor or other detection device 44 that identifies the presence of the license plate frame 24. Such sensors or detection device 44 can be auto-ID technologies such as optical character recognition, bar codes, and radio frequency identifiers (RFID's). Optical character readers view the license plate frame 24 and identify the presence of the frame 24. In a barcode system, the license plate 24 includes a barcode and the location associated with the entity includes a barcode reader to identify the presence of the frame 24. In an RFID system, the license plate frame 24 includes an RFID tag 48 (SEE FIG. 2), which includes a microchip and a radio antenna, and the location associated with the entity includes a reader 44 (see FIG. 1), which includes one or more antennas that emit radio waves and receive signals back from the tag 48, for identifying the presence of the RFID tag 48. After the entity identifies the presence of a license plate frame 24 with the electronic detection device 44, the consumer is provided with a discount similar to the discount options described above in connection with the first manner of operation.

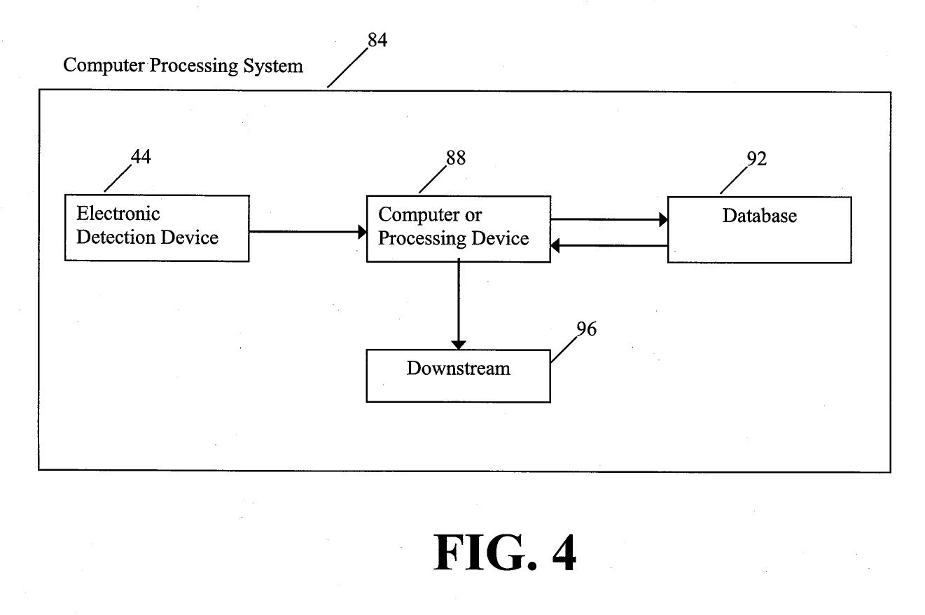

As an alternative, the electronic detection device 44 can have further functionality. For example, with reference to FIG. 4, the electronic detection device 44 may be part of a computer or processing system 84. In such a system 84, the electronic detection device 44 may identify the frame 24 and may send information relating to the identified frame 24 to a computer or processing device 88. The computer or processing device 88 may then communicate with a database 92 containing an inventory of frames to identify the frame 24 scanned by the electronic detection device 44. In other words, the scanned frame 24 is being singled out as a particular one of a plurality of frames 24 stored in the database 92 inventory of frames. Information associated with the frames 24 may be stored in the database 92. Such information may relate to, for example, details about the consumer, details about the discount associated with the license plate frame 24 and consumer special instructions or information relating to the transaction, etc. Next, the computer or processing device 88 retrieves the necessary information from the database 92 associated with the scanned frame 24, performing any necessary processing or compilation with the information, and communicates relevant information downstream 96 for further processing or to carry out the discount.

With particular reference to the RFID system, the microchip in the RFID tag 48 stores data associated with the consumer and/or the consumer's automobile 28, the reader 44 communicates with the tag 48, and the reader 44 passes the information received from the tag 48 (i.e., consumer and/or automobile information) to the computer or processing system 88 for identifying and processing operations. For example, a first consumer has a first license plate frame 24 coupled to his/her vehicle 28 and a second consumer has a second license plate frame 24 coupled to his/her vehicle 28. The first consumer is eligible for a 25% discount of a product or service from an entity and the second consumer is eligible for a 10% discount of a product or service from the entity. When the first consumer drives his/her vehicle to a location associated with the entity, the presence of the license plate frame 24 is detected and the first consumer receives a 25% discount on the product or service. When the second consumer drives his/her vehicle to a location associated with the entity, the presence of the license plate frame 24 is detected and the second consumer receives a 10% discount on the product or service.

It should be understood that the alternative apparatuses 24 introduced above can include indicia 36 similar to the indicia 36 included on the license plate frame 24, can similarly provide advertising for the entity associated with the indicia 36, and can provide a discount for the consumer upon visiting a location associated with the entity. Similarly to the license plate frame 24, these alternative apparatuses 24 can be either visually detected or detected with an electronic system.

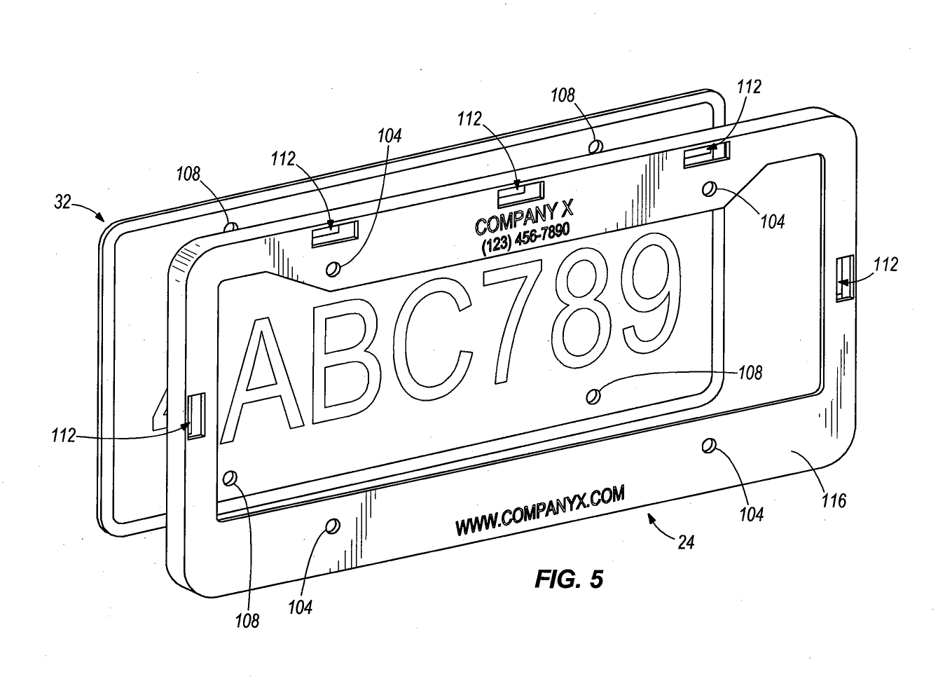

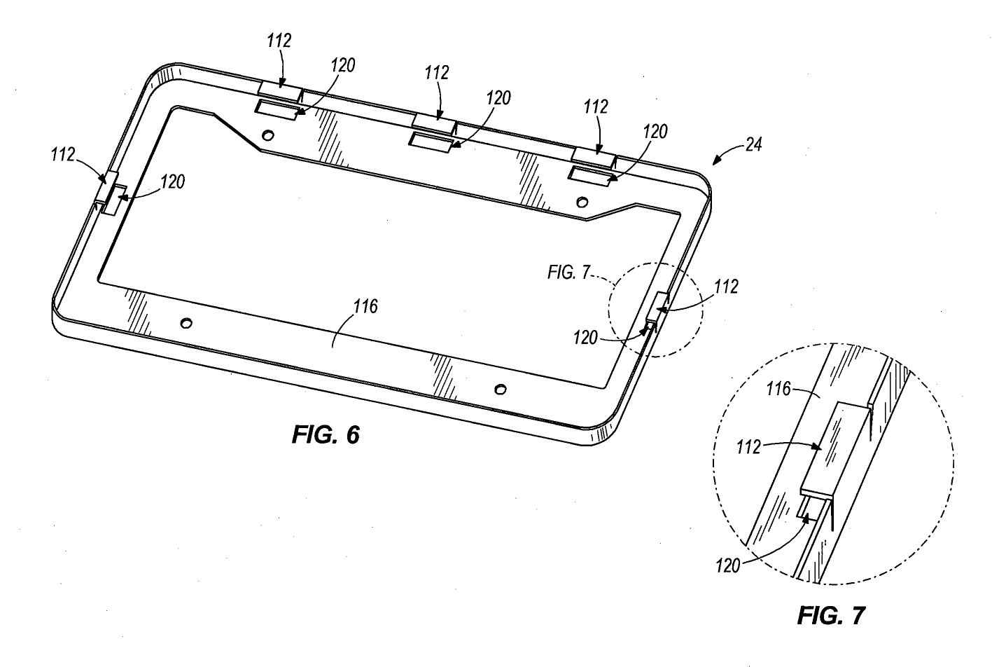

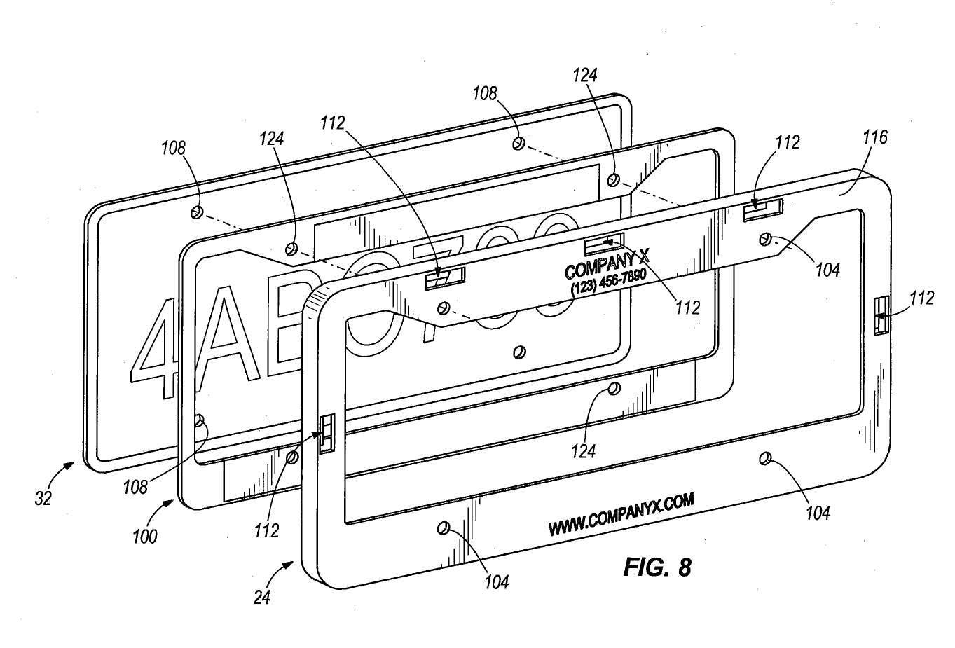

Referring now to FIGS. 5-8, another exemplary apparatus 24 is illustrated. In the illustrated example, the apparatus is a license plate frame 24 capable of including all of the features and alternatives presented above in connection with the apparatuses 24 described above and shown in FIGS. 1-4. The following description pertaining to FIGS. 5-8 will relate particularly to manners of coupling the license plate frame 24 to an automobile 28, a license plate 32, and/or an existing license plate frame 100 previously coupled to the automobile 28. While indicia is not illustrated on the frame 24 shown in FIGS. 5-8, the frame 24 is capable of having indicia thereon and capable of performing with the discount system 20 in the same manner as the frames 24 described above and illustrated in FIGS. 1-4.

With particular reference to FIGS. 5-7, the license plate frame 24 is shown in an embodiment where it is coupled directly to a license plate 32. In this illustrated example, the license plate frame 24 includes a plurality of apertures 104 that are alignable with apertures 108 present in the license plate 32. Fasteners are capable of being inserted through the apertures 104, 108 in both the license plate frame 24 and the license plate 32 to couple the frame 24 and the license plate 32 to the automobile 28.

The frame 24 also includes another manner for coupling the frame 24 directly to the license plate 32. The frame 24 includes a plurality of tabs 112 displaced rearwardly from a front surface 116 of the frame 24, thereby providing a gap 120 between the front face 116 of the frame 24 and the tabs 112. In some examples, the gap 120 may be between about 5/16^{th} of an inch and about 7/16^{th} of an inch. Alternatively, the gap 120 may be different sizes to accommodate different thicknesses of license plates 32. In the illustrated example, the frame 24 includes five tabs 112 with three tabs 112 disposed along a top edge of the frame 24 and a single tab 112 disposed along each side edge of the frame 24. Alternatively, the frame 24 may include any number of tabs 112 and the tabs 112 may be disposed anywhere on the frame 24.

To couple the frame 24 to the license plate 32 with the tabs 112, the tabs 112 are positioned behind and around the associated edges of the license plate 32 such that the license plate 32 is disposed in the gap 120 between the tabs 112 and the front surface 116 of the frame 24. Accordingly, the license plate 32 is trapped between the tabs 112 and the front surface 116 of the frame 24 to couple the frame 24 to the license plate 32. It should be understood that the frame 24 may be coupled to the license plate 32 by utilizing both manners disclosed herein or by either one of the manners disclosed herein. That is, the frame 24 may be coupled to the license plate 32 by using fasteners alone, the tabs 112 alone, or both the fasteners and tabs 112.

Referring now to FIG. 8, the frame 24 illustrated in FIGS. 5-7 is illustrated in an embodiment where it is coupled to a license plate frame 100 previously coupled to the license plate 32 and/or automobile 28. In this example, the frame 24 is substantially identical to the frame 24 illustrated in FIGS. 5-7. Similarly, the frame 24 includes a plurality of apertures 104 aligned with apertures 108 present in the license plate and apertures 124 present in the previously installed license plate frame 100 for coupling the frame 24 to the previously installed license plate frame 100 and license plate 32.

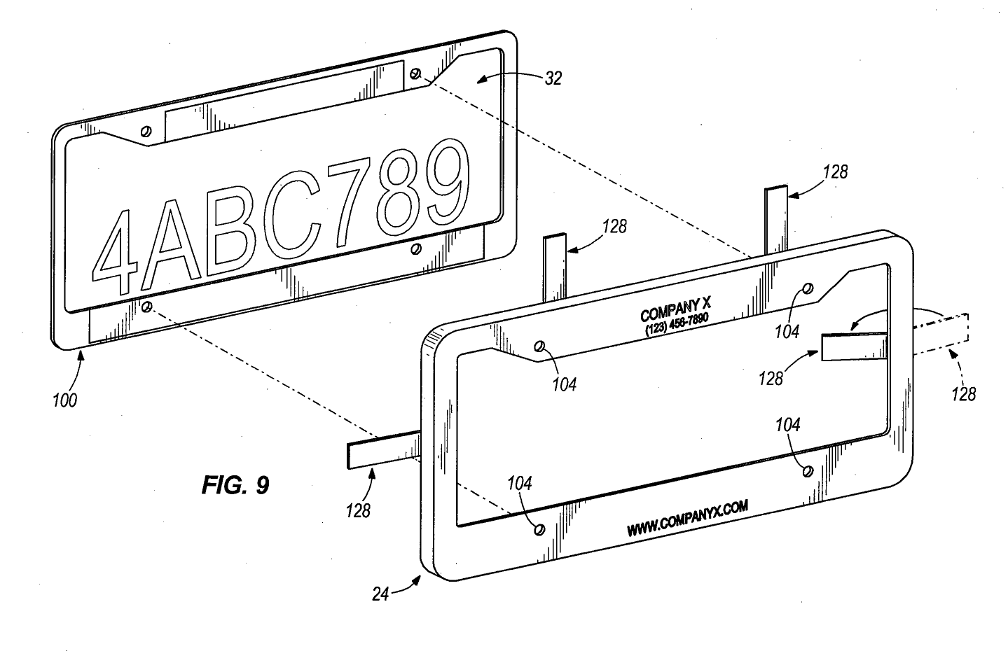

Also, the frame 24 includes a plurality of tabs 112 for coupling the frame 24 to the previously installed license plate frame 100 and the license plate 32. The gap 120 provided between the tabs 112 and the front surface 116 of the frame 24 is sufficiently sized to accommodate the thickness of both the license plate 32 and the previously installed license plate frame 100. Similarly to the frame described above with reference to FIGS. 5-7, the gap 120 of FIG. 9 may be between about 5/16^{th} of an inch and about 7/16^{th} of an inch. Alternatively, the gap 120 may be different sizes to accommodate different thicknesses of license plate frames 100 and license plates 32.

To couple the frame 24 to the license plate 32 and the previously installed license plate frame 100 with the tabs 112, the tabs 112 are positioned behind and around the associated edges of the license plate 32 and the previously installed license plate frame 100 such that the license plate 32 and previously installed license plate frame 100 are disposed in the gap 120 between the tabs 112 and the front surface 116 of the frame 24. Accordingly, the license plate 32 and previously installed license plate frame 100 are trapped between the tabs 112 and the front surface 116 of the frame 24 to couple the frame 24 to the license plate 32 and previously installed license plate frame 100. It should be understood that the frame 24 may be coupled to the license plate 32 and previously installed license plate frame 100 by utilizing both manners disclosed herein or by either one of the manners disclosed herein. That is, the frame 24 may be coupled to the license plate 32 and the previously installed license plate frame 100 by using fasteners alone, the tabs 112 alone, or both the fasteners and tabs 112.

Referring now to FIG. 9, another exemplary license plate frame 24 is illustrated. In this illustrated example, the apparatus is a license plate frame 24 capable of including all of the features and alternatives presented above in connection with the apparatuses 24 described above and shown in FIGS. 1-8. The following description pertaining to FIG. 9 will relate particularly to manners of coupling the license plate frame 24 to an automobile 28, a license plate 32, and/or an existing license plate frame 100 previously coupled to the automobile 28. While indicia is not illustrated on the frame 24 shown in FIG. 9, the frame 24 is capable of having indicia thereon and capable of performing with the discount system 20 in the same manner as the frames 24 described above and illustrated in FIGS. 1-8.

Similarly to the license plate frame 24 illustrated in FIGS. 5-8, the frame 24 illustrated in FIG. 9 may be coupled directly to a license plate 32 or to a previously installed license plate frame 100. The example illustrated in FIG. 9 shows the frame 24 coupled to a previously installed license plate frame 100 and a license plate 32. The frame 24 of FIG. 9 includes a plurality of apertures 104 therein alignable with apertures 108, 124 present in both the license plate 32 and the previously installed license plate frame 100. Fasteners may be inserted through the apertures 104, 108, 124 in the frame 24, the previously installed license plate frame 100, and the license plate 32 to couple the frame 24 to the previously installed license plate frame 100, the license plate 32, and ultimately to the automobile 28.

The frame 24 also includes another manner for coupling the frame 24 to the previously installed license plate frame 100 and license plate 32. The frame 24 includes a plurality of bendable tabs 128 with each tab 128 include a living hinge to allow the tab 128 to move between an outer or uncoupled position (see top two tabs, left tab, and dashed lines of right tab in FIG. 9) and an inner or coupled position (see solid right tab in FIG. 9). In the illustrated example, the frame 24 includes four tabs 128 with two tabs 128 on the top edge of the frame 24 and one tab 128 on each side edge of the frame 24. Alternatively, the frame 24 may include any number of tabs 128 and the tabs 128 may be positioned anywhere on the frame 24. The frame 24 may be made of a variety of materials including, for example, polypropylene. Alternatively, the frame 24 may be made of any other material appropriate for this application.

To couple the frame 24 of FIG. 9 to the license plate 32 and the previously installed license plate frame 100 with the bendable tabs 128, the frame 24 is positioned against a front of the previously installed license plate frame 100 such that the frame 24 covers the front face of the previously installed license plate frame 100 and the bendable tabs 128 are in the uncoupled position. The tabs 128 are then bent along the living hinge of the tabs 128 from the uncoupled position to the coupled position such that the bendable portions of the tabs 128 are moved behind the license plate 32 and the previously installed license plate frame 100. The license plate 32 and the previously installed license plate frame 100 are trapped between the tabs 128 and the front face 116 of the frame 24 to couple the frame 24 to the license plate 32 and previously installed license plate frame 100. It should be understood that the frame 24 may be coupled to the license plate 32 and previously installed license plate frame 100 by utilizing both manners disclosed herein or by either one of the manners disclosed herein. That is, the frame 24 may be coupled to the license plate 32 and the previously installed license plate frame 100 by using fasteners alone, the bendable tabs 128 alone, or both the fasteners and bendable tabs 128. It should also be understood that the frame 24 of FIG. 9 including the bendable tabs 128 may be coupled directly to the license plate 32, without a previously installed license plate frame 100, in both manners disclosed herein or in either one of the manners disclosed herein.

The foregoing description has been presented for purposes of illustration and description, and is not intended to be exhaustive or to limit the invention to the precise form disclosed. The descriptions were selected to explain the principles of the invention and their practical application to enable others skilled in the art to utilize the invention in various embodiments and various modifications as are suited to the particular use contemplated. Although particular constructions of the present invention have been shown and described, other alternative constructions will be apparent to those skilled in the art and are within the intended scope of the present invention.

We claim:

1. A method of providing a discount, the method comprising:
providing a license plate frame including indicia thereon associated with an entity;
coupling the license plate frame to an automobile such that the license plate frame at least partially surrounds a license plate coupled to the automobile;
detecting the presence of the license plate frame at a location associated with the entity; and
providing a discount for a product or a service associated with the entity after detection of the license plate frame.

2. The method of claim 1, wherein the location associated with the entity is a second location and after coupling the license plate frame to an automobile, the method further comprises driving the automobile to a first location not associated with the entity and visually detecting the presence of the license plate frame at the first location;

3. The method of claim 2, further comprising driving the automobile to the second location associated with the entity prior to detecting the presence of the license plate frame at the second location associated with the entity.

4. The method of claim 1, wherein detecting the presence of the license plate frame at the location associated with the entity further includes visually detecting the presence of the license plate frame at the location by a person associated with the entity.

5. The method of claim 1, wherein detecting the presence of the license plate frame at the location associated with the entity further includes electronically detecting the presence of the license plate frame at the location associated with the entity.

6. The method of claim 5, wherein after electronically detecting the presence of the license plate frame, the method further comprises providing information relating to the detected license plate frame to a computer system and determining a characteristic of the discount to be provided dependent on the information relating to the license plate frame.

7. The method of claim 6, wherein providing the discount further comprises providing the discount having the characteristic determined dependent on the information relating to the license plate frame.

8. The method of claim 1, wherein providing a license plate frame further includes providing a license plate frame including a tab and wherein coupling the license plate frame to the automobile further includes coupling the license plate frame to the automobile with the tab.

9. A method of providing a discount, the method comprising:
providing a license plate frame including indicia thereon associated with an entity;
coupling the license plate frame to an automobile such that the license plate frame at least partially surrounds a license plate coupled to the automobile;
driving the automobile to a first location not associated with the entity;
visually detecting the presence of the license plate frame at the first location;
driving the automobile to a second location associated with the entity;
detecting the presence of the license plate frame at the second location; and
providing a discount for a product or a service associated with the entity after detection of the license plate frame.

10. The method of claim 9, wherein visually detecting the presence of the license plate frame at the first location further includes visually detecting the presence of the license plate frame at the first location by a person not associated with the entity.

11. The method of claim 9, wherein detecting the presence of the license plate frame at the second location further includes visually detecting the presence of the license plate frame at the second location.

12. The method of claim 11, wherein visually detecting the presence of the license plate frame at a second location is performed by a person associated with the entity.

13. The method of claim 9, wherein detecting the presence of the license plate frame at the second location further includes electronically detecting the presence of the license plate frame at the second location.

14. The method of claim 13, wherein electronically detecting further includes electronically detecting the presence of the license plate frame at the second location with an optical character recognition device.

15. The method of claim 13, wherein electronically detecting further includes electronically detecting the presence of the license plate frame at the second location with a bar code device.

16. The method of claim 13, wherein providing a license plate frame further includes providing a license plate frame including a radio frequency identifier tag, and wherein electronically detecting further includes electronically detecting the presence of the license plate frame at the second location with a radio frequency identifier device that communicates with the radio frequency identifier tag.

17. The method of claim 13, wherein after electronically detecting the presence of the license plate frame, the method further comprises providing information relating to the detected license plate frame to a computer system and determining a characteristic of the discount to be provided dependent on the information relating to the license plate frame.

18. The method of claim 17, wherein providing the discount further comprises providing the discount having the characteristic determined dependent on the information relating to the license plate frame.

19. The method of claim 9, wherein the indicia is at least one of a name of the entity, a website associated with the entity, a phone number associated with the entity, a logo associated with the entity, a slogan associated with the entity, an illustration associated with the entity, and the discount provided for the product or service.

20. The method of claim 9, wherein providing a license plate frame further includes providing a license plate frame including a tab and wherein coupling the license plate frame to the automobile further includes coupling the license plate frame to the automobile with the tab.

21. A discount system for providing a discount for a product or a service associated with an entity, the discount system comprising:
a license plate frame operable to be coupled to an automobile such that the license plate frame at least partially surrounds a license plate, the license plate frame including indicia thereon associated with the entity.

22. The discount system of claim 21, wherein the indicia is at least one of a name of the entity, a website associated with the entity, a phone number associated with the entity, a logo associated with the entity, a slogan associated with the entity, an illustration associated with the entity, and the discount provided for the product or service.

23. The discount system of claim 21, wherein the license plate frame includes a radio frequency identifier.

24. The system of claim 21, wherein a discount is provided upon detection of the license plate frame at a location associated with the entity.

25. The system of claim 21, wherein the license plate frame further includes a tab for coupling the license plate frame to the automobile.
